(19) United States
(12) Patent Application Publication
(10) Pub. No.: US 2003/0033155 A1
(43) Pub. Date: Feb. 13, 2003

(54) Integration of data for user analysis according to departmental perspectives of a customer

(76) Inventors: Randy Peerson, San Mateo, CA (US); Terris Linenbach, Burlingame, CA (US)

Correspondence Address: OPPENHEIMER WOLFF & DONNELLY, P. O. BOX 10356, PALO ALTO, CA, 94303, US

(21) Appl. No.: 09/860,947

(22) Filed: May 17, 2001

(51) Int. Cl. G06F 17/60

(52) U.S. Cl. 705/1

(57) ABSTRACT

A method is afforded for providing analytical information to a customer. Departmental data is received from a customer. A first set of data associated with a user is also received from the customer. A second set of data associated with the user is accessed. The data received from the customer, as well as the data accessed, is integrated. The integrated data is then stored in a warehouse. Analytical information is provided to the customer based on the integrated data stored in the warehouse.

### TECHNICAL FIELD

The present invention relates generally to data analysis, and more particularly to the integration of data for user analysis according to departmental perspectives of a customer.

### BACKGROUND ART

In earlier days of the web when Web-based ventures had relatively fewer visitors, their tools only read flat log files and reported on basic information such as page views and ad clicks. With the exponential growth of web traffic, many Internet businesses have realized the importance of capturing, extending, and analyzing their click stream data. In addition to handling increased traffic, web-based ventures currently must incorporate data from sources that did not exist several years ago, such as application servers and media servers. In addition, mergers and acquisitions of web companies and the introduction of new technologies results in disparate data sources, making collection and analysis extremely difficult.

Furthermore, moving data between systems often requires that data be converted to a common structure, cleaned and enhanced to adhere to the new system design and constraints. Some data flows involve collating data from several source systems on a regularly scheduled process. This can involve complex scheduling, monitoring, error handling, and auditing of interfaces across many platforms. Data flows can trigger the movement of massive data volumes in short time frames followed by ongoing or periodic feeds to target systems in order to reflect changes occurring on the source system. Careful planning and control over development and runtime environments is key to successfully addressing these many issues and with growing numbers of connected systems, both within and outside the enterprise, it is becoming increasingly difficult to manage.

Companies today primarily use traffic analysis tools to gain an understanding of traffic patterns. Traffic analysis tools may read a web log, perform a lookup on the IP addresses to acquire the URL of the visitor and generate reports. However, traffic analysis tools only report on a limited amount of data. The data is not stored perpetually for additional analysis.

Traffic analysis tools have been very useful for webmasters to identify top entry pages, top exit pages, and top domains visiting the site. The web log has the information required to provide these metrics. Traffic analysis, however, provides little information for a VP of Sales or a VP of Marketing, for example. Identifying the leading entry page or leading exit page may not help the VP of Sales acquire revenue or the VP of Marketing target industries or companies. Therefore, more than traffic analysis may be required to understand a user.

### SUMMARY OF THE INVENTION

Accordingly, it is an object of the present invention to provide a method for the integration of data for user analysis according to departmental perspectives of a customer.

It is another object of the invention to segment users by industry, company revenue, and geographic location.

It is yet another object of the present invention to provide third party data integrated with customer web log data and customer departmental data.

It is a further object of the present invention to provide up to date data analysis.

Still another object of the present invention is to provide a comprehensive understanding of a user.

It is yet another object of the present invention to turn web log data into high quality analytics and business results.

Another object of the present invention is to provide improved relationships between companies and their web users.

Briefly, a preferred embodiment of the present invention is a method for providing analytical information to a customer. Departmental data is received from a customer. The departmental data may include customer relationship management data, marketing data, operations data, sales force data, or transactions data. A first set of data associated with a user is also received from the customer. The first set of data may include web log data, which may be converted into a standard format. The web log data may be collected from a local server or a remote server. A second set of data associated with the user is accessed. The second set of data may be accessed from a third party database or a server associated with a service provider. The second set of data may include firmagraphic data, demographic data, industry code, or revenue. The data received from the customer, as well as the data accessed, is integrated. The integrated data is then stored in a warehouse. Analytical information is provided to the customer based on the integrated data stored in the warehouse. The analytical information may be provided to the customer via a portal, spatial mapping, a query, or a handheld device. Further, the customer may access the warehouse to extract data or insert new data.

An advantage of the present invention is that it may be utilized, for example, by web-based companies or brick and mortar establishments providing online information or services to a user.

Another advantage of the present invention is the delivery of immediate insight into a user.

A further advantage of the present invention is that is provides information associated with the behavior patterns and web site activity of a user as it pertains to customer relationship management of the user.

Yet another advantage of the present invention is that it provides a unique perspective of sales, marketing, operations, customer relationship management, transactions, etc.

Still another advantage of the present invention is that is provides for improved customer relations with users.

A further advantage of the present invention is that it provides for improved overall web presence.

These and other objects and advantages of the present invention will become clear to those skilled in the art in view of the description of the best presently known modes of carrying out the invention and the applicability of the preferred and alternate embodiments as described herein and as illustrated in the several figures of the drawings.

### BRIEF DESCRIPTION OF THE DRAWINGS

FIG. 1 is a flowchart illustrating a process for providing analytical information to a customer;

FIG. 2 is a schematic diagram depicting architecture in accordance with an embodiment of the present invention;

FIG. 3 is a flowchart illustrating a process for resolving information associated with a user in accordance with an embodiment of the present invention;

FIG. 4 is a schematic diagram depicting backend and front-end architectures in accordance with an embodiment of the present invention;

FIG. 5 is a schematic diagram depicting diversified backend and front-end architectures in accordance with an embodiment of the present invention;

FIG. 6 is a schematic diagram depicting application service provider and customer architecture in accordance with an embodiment of the present invention;

FIG. 7 is a schematic diagram depicting a typical web log in accordance with an embodiment of the present invention;

FIG. 8 is a schematic diagram depicting a standardized format in accordance with an embodiment of the present invention;

FIG. 9 is a schematic diagram depicting a hardware implementation of a data replicator in accordance with an embodiment of the present invention;

FIG. 10 is a flowchart depicting software components of a data replicator in accordance with an embodiment of the present invention; and

FIG. 11 is a schematic diagram depicting an import and export process of a data replicator in accordance with an embodiment of the present invention.

### BEST MODE FOR CARRYING OUT THE INVENTION

The present invention is a process for integrating data for departmental analysis. The integration of disparate data provides information to customers of a service provider about users or their potential customers.

Table 1 below is a glossary of various acronyms used throughout the current patent application.

TABLE 1

| | |
|---|---|
| ASP | Application Service Provider |
| COM | Component Object Model |
| CRM | Customer Relationship Management |
| DCM | Data Collection Manager |
| ETL | Extraction, transformation and load |
| HTTP | Hypertext Transfer Protocol |
| HTTPS | Secure Hypertext Transfer Protocol |
| IP | Internet Protocol |
| KPI | Key Performance Indicator: A symbol (e.g. an arrow) indicating |
| | change in one predefined data dimension |
| MOLAP | Online Analytical Processing (data stored in a |
| | “multidimensional database”) |
| ODBC | Open Database Connectivity |
| OLEDB | OLE DB (which once stood for Object Linking and Embedding |
| | Database) is Microsoft's (TM) strategic low-level application program |
| | interface for access to different data sources. OLE DB includes not |
| | only the Structured Query Language (SQL) capabilities of the |
| | Microsoft-sponsored standard data interface Open Database |
| | Connectivity but also includes access to data other than SQL data. |
| SNMP | Simple Network Management Protocol |
| URL | Uniform Resource Locator |
| XML | Extensible Markup Language |

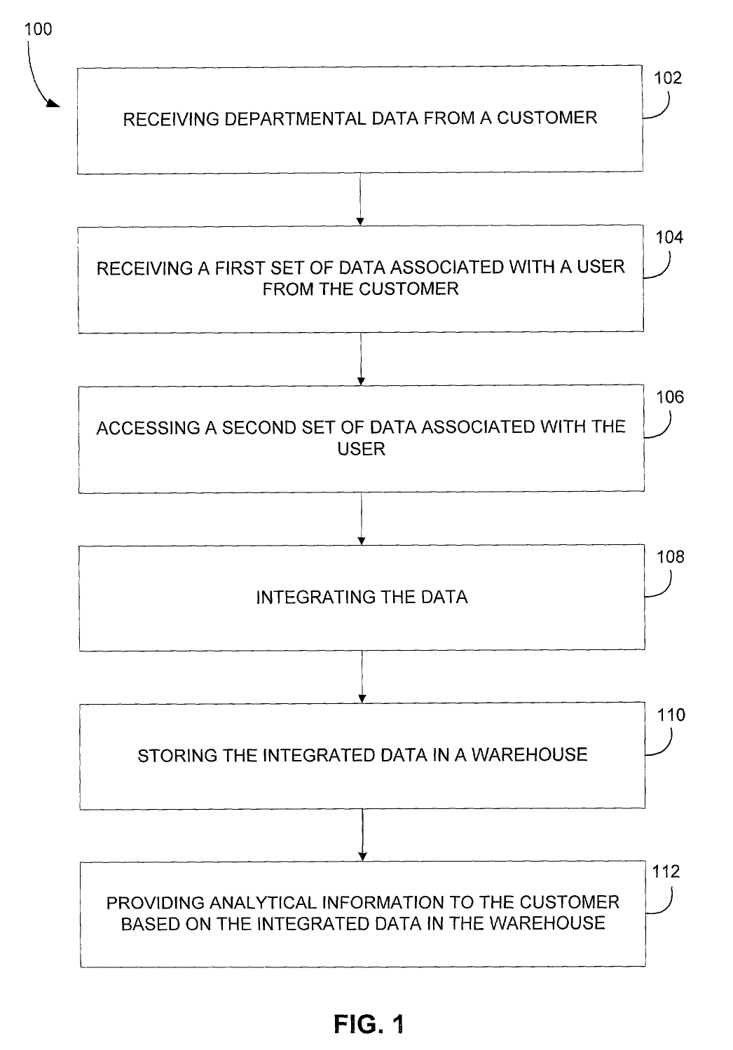

FIG. 1 is a flowchart illustrating a process 100 for providing analytical information to a customer. In operation 102, departmental data is received from a customer. A first set of data associated with a user is received from the customer in operation 104. In operation 106, a second set of data associated with the user is accessed. The data is integrated in operation 108. In operation 110, the integrated data is stored in a warehouse. Analytical information is provided to the customer based on the integrated data stored in the warehouse in operation 112.

The analytical information provided to the customer may provide insight into potential clients. For example, a sales representative employed by the customer may realize sales opportunities from the analytical information. For instance, the company with which a user is associated, combined with information about the company, and data related to the sales department of the customer may reveal a need for a certain product or service of the customer in the industry of the company. In other words, sales representative John Doe is an employee of the customer. Through accessing the analytical information provided to the customer, John Doe realizes that user number 1 has visited the web site of the customer 20 times in one month and the user has typically looked at one or more particular products or services of the customer for whom John Doe is a sales representative. John Doe also learns from the analytical information that user number 1 is from a company named Red Inc. Furthermore, the analytical information provides the industry code, address, phone number, revenue, number of employees, etc. about Red Inc. John Doe also learns from the analytical information that Red Inc. is in his sales territory. Thus, utilizing the analytical information provided, John Doe has realized a potential sales opportunity with Red Inc.

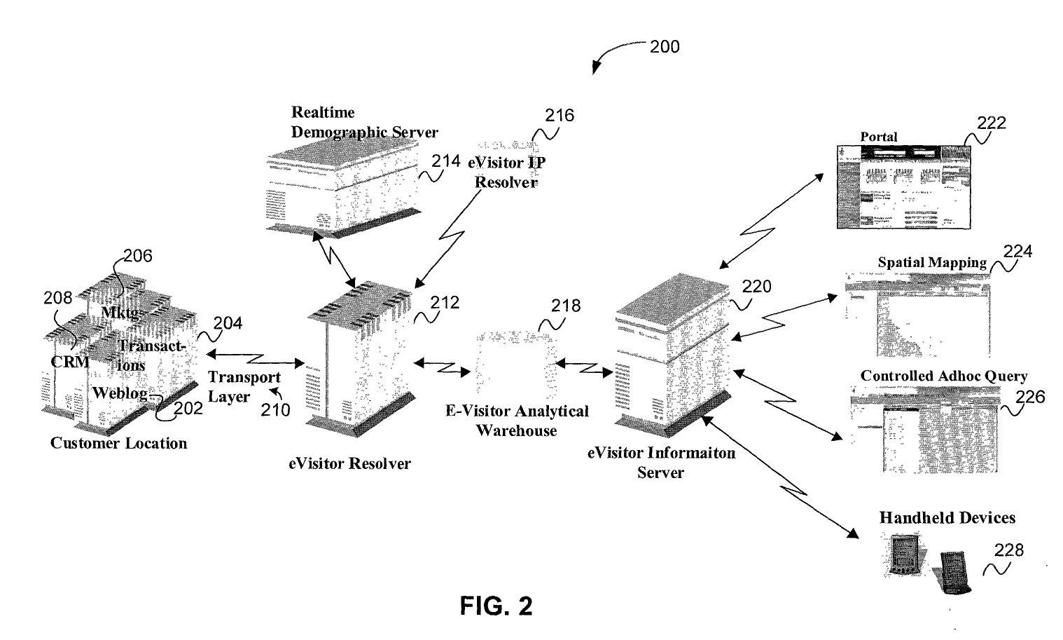

FIG. 2 is a schematic diagram depicting architecture 200 in accordance with an embodiment of the present invention. The customer location includes a web log 202 in the present embodiment. The customer location may also include data associated with transactions 204, marketing 206, or customer relationship management (CRM) 208. A service provider, such as an application service provider (ASP), may access the customer data via a transport layer 210 and cleanse the data via a resolver 212. Data from a demographic server 214 may also be sent to the resolver 212. The demographic server 214 may also receive information from the resolver 212. In addition, the resolver 212 may receive data from a user IP resolver 216.

The data from the resolver 212 may be transferred to a data warehouse 218 for storage and access by the customer. The information server 220 may be accessed by the customer in order to retrieve information from the data warehouse 218. The information server 220 may distribute the information stored in the data warehouse 218 via a portal 222, spatial mapping 224, adhoc query 226, or a handheld device 228.

The ASP has access to data at the customer location. This customer information may include departmental data, such as the aforementioned transactional 204, marketing 206, and CRM 208 information. In addition, customer departmental data may include data associated with sales, such as sales force data. The customer data may be integrated with other forms of data and stored in the data warehouse 218. One other form of data with which the customer data may be integrated is data from the demographic server 214 (i.e. third party data). Data from the demographic server 214 may include data associated with companies. For example, the demographic server 214 may provide a company's address, standard industrial classification (sic), number of employees, or annual revenue.

The user IP resolver 216 may provide data to the ASP resolver 212. The data provided by the user IP resolver 216 may include a URL obtained utilizing the IP address of the user. The IP address or URL may be utilized to obtain the name of a company associated therewith. The ASP resolver 212 may then utilize the URL or the name of the company to obtain information associated with the company from the demographic server. The ASP resolver 212 may store information associated with the company in order to allow rapid access and more efficient future delivery of this third party data associated with the company.

The information obtained from the demographic server 214 may be integrated with the data from the customer location, including the web log 202 data or the departmental data. The integrated data is stored in the data warehouse 218 in the present embodiment. A data warehouse is associated with each customer in order to prevent the sharing of customer data with other customers.

In the present embodiment, the integrated data stored in the data warehouse 218 is sent to the information server 220 in order to distribute the integrated data to the customer in various forms. As previously discussed, the customer may receive the integrated data through a portal 222. In addition, the customer may receive the integrated data via spatial mapping 224 or via adhoc query 226. The adhoc query 226 may be a controlled adhoc query. Handheld devices 228 may also be utilized by the customer to access the integrated information through the information server 220. The information displayed to the customer may be sent back to the information server 220 to allow for quicker access to the information upon future inquiries. In addition, the customer may provide updated information through the information server 220.

The IP resolver 216 can be a COM object that accepts an XML document and returns an XML document. It may follow an XML-Acceptor pattern. The request document may specify the IP address to resolve.

The IP resolver 216 may also use a Strategy pattern. The IP resolver 216 component itself may not know how to look up firmagraphic data. Strategy objects can be responsible for this function. The strategy components can look up firmagraphic data using a provided IP address. New strategy components can be added to the system dynamically by modifying a configuration text file (which may be the file format XML).

The strategy components may return firmagraphics in an XML document. XML may be chosen based on two criteria: time to market and flexibility. Strategy components may “stream” XML to each other. For example, one component may add a “domain” attribute to the XML document, and another component may read that attribute and send it to a whois server. This may allow components to flexibly “communicate” with each other without tightly coupling them. Furthermore, XML documents can be a lot easier to manipulate than, for example, OLEDB record sets.

Components in a “plan” may not be aware of each other. This may allow components to be “wired” together in an infinite number of ways. The system can be open-ended. As the component library increases, plans can become more and more powerful.

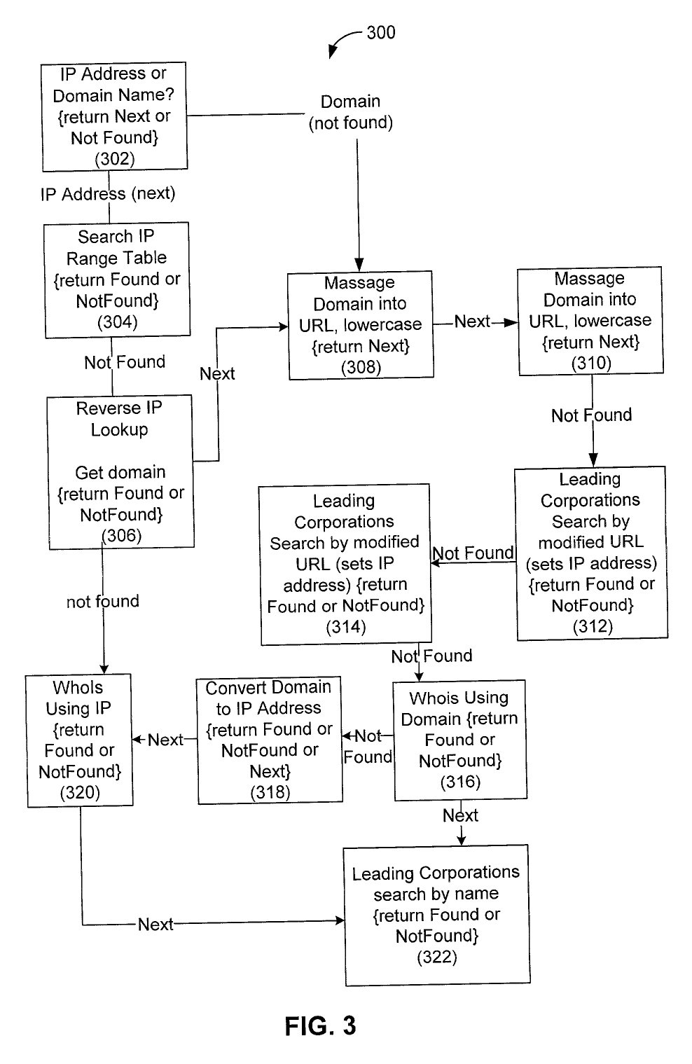

FIG. 3 is a flowchart illustrating a process 300 for resolving information associated with a user in accordance with an embodiment of the present invention. In operation 302, it can be determined whether an IP address or domain name has been identified. If a domain has been input, it may be converted to an IP address. If an IP address has been identified, an IP range table may be searched in operation 304. In operation 306, a domain may be retrieved through a reverse IP lookup process if it was not identified through the search of the IP range table in operation 304. If the domain is found in operation 306, the domain may be massaged into a URL in operation 308. Similarly, if the domain is identified in operation 302, it may next be massaged into a URL in operation 308 without necessarily utilizing the processes defined in operations 304 or 306. In operation 310, a company dimension may be searched by URL. A database may contain this company dimension table that can store information on companies that have been previously resolved. A leading corporation search by URL may be performed in operation 312 if the company dimension by URL is not found in operation 310. Thus, if the URL from the domain matches a URL in the leading corporations dimension, then the information for the record, such as company name, revenue, industry, etc., can be integrated with the URL. In operation 314, a leading corporations search by modified URL may be performed if the corporation was not found in operation 312. In other words, a modified IP address for inputs from a domain or IP addresses that have been previously resolved may be created. A search of a whois server using the domain may be performed in operation 316 if the corporation was not found in operation 314. In operation 318, the domain may be converted to an IP address if the corporation was not found in operation 316 utilizing the domain. Next, a search of a whois server using the IP address may be performed in operation 320. Similarly, a search of a whois server using the IP address may be performed in operation 320, following operation 306 if operation does not reveal a domain. In this scenario, steps 308 through 318 may not be necessary. Once a search of a whois server using the IP address is performed in operation 320, a leading corporations search by name may be performed in operation 322. Similarly, once a search of a whois server using the domain is performed in operation 316, a leading corporations search by name may be performed in operation 322.

A whois server can maintain registrant information for Internet domains. There may be hundreds of whois servers around the world that maintain a registrant database. Thus, an IP address may be provided to a whois server in order to acquire the registrant information associated therewith. A whois server can also provide registrant information from a domain. Thus, a whois server may provide registrant information associated with a domain.

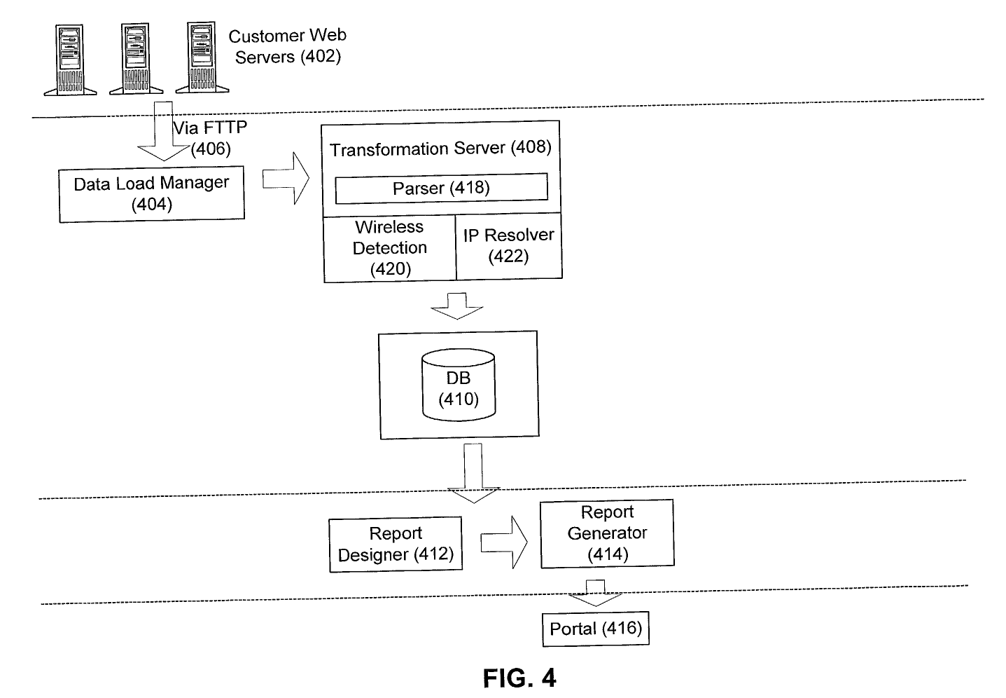

FIG. 4 is a schematic diagram depicting backend and front-end architectures 400 in accordance with an embodiment of the present invention. At the backend of the service provider are customer web servers 402 in the current embodiment. The customer web servers 402 deliver data to a data load manager 404 via FTP 406, for example. The data load manager 404 delivers data to a transformation server 408. The transformation server 408 then delivers information to a database 410.

At the service provider front-end, a report designer 412 may retrieve information from the database 410 and transport the data to a report generator 414, which may produce a report utilizing the data. The report generator 414 may deliver the data to a portal 416, allowing the customer to access the report or data. The portal 416 is at the customer front-end in the current embodiment.

The transformation server 408 may include a parser 418. Also included on the transformation server 408 may be wireless detection 420 and an IP resolver 422.

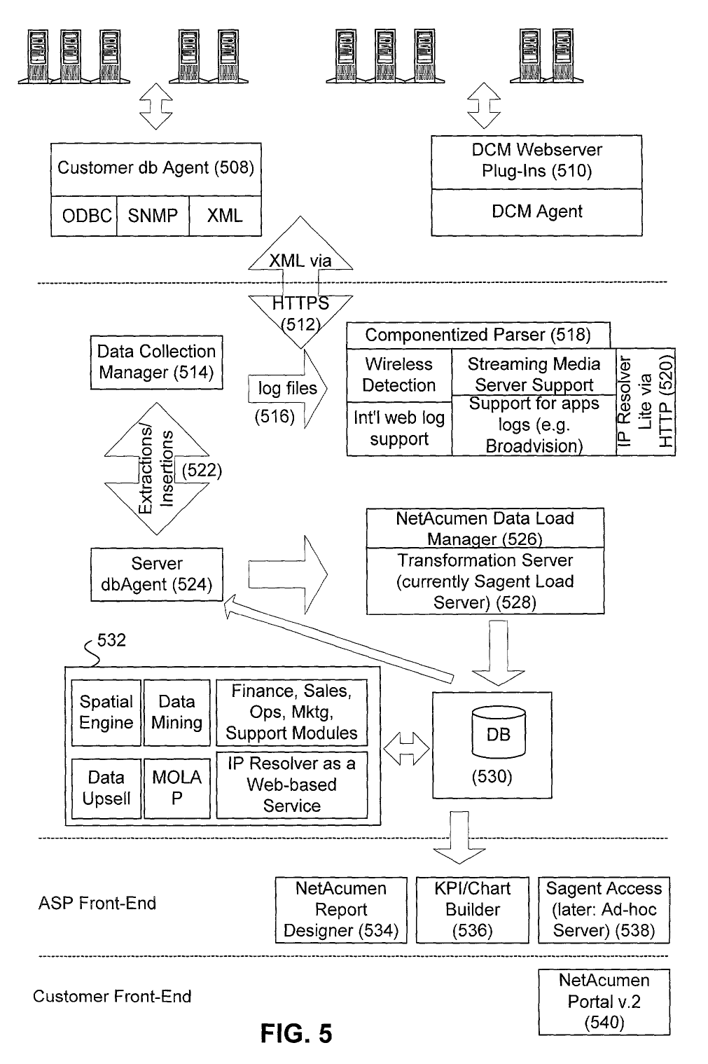

FIG. 5 is a schematic diagram depicting diversified backend and front-end architectures 500 in accordance with an embodiment of the present invention. Local application servers 502 and remote application servers 504 reside at the customer backend in the current embodiment. The respective application servers 502, 504 may extract or insert 506 data from a customer database agent 508 or via data collection manager (DCM) web server plug-ins 510. The customer database agent 508 may transport data via ODBC, SNMP, XML, etc. The DCM web server plug-ins 510 may utilize a DCM agent. The data may be delivered to the service provider as XML via HTTPS 512, for example. The data may be delivered to a data collection manager (DCM) 514 at the service provider backend. Log files 516 may be delivered from the DCM 514 to a componentized parser 518. The componentized parser 518 may include wireless detection, streaming media server support, international web log support, support for application logs, etc. In addition, the componentized parser 518 may include an IP resolver lite 520 component. The componentized parser 518 may be a component of the DCM 514. Extractions or insertions 522 may be effected on the DCM 514 by a server database agent 524, and vice versa. The server database agent 524 or the componentized parser 518 may deliver data to a data load manager 526. The data load manager 526 may include a transformation server 528. The data from the data load manager 526 and transformation server 528 can be sent to a database 530. The database 530 may deliver data back to the server database agent 524. Data may be exchanged between the database 530 and service provider applications 532. The service provider applications 532 may include a spatial engine, data mining, a finance module, a sales module, a operations module, a marketing module, a support module, data upsell, MOLAP, IP resolver web-based service, etc. The data from the service provider modules 532 may be integrated with data from the data load manager 526 and transformation server 528 and routed back to the customer back-end via the server database agent 524. Data from the database 530 may be delivered to the service provider front-end to a report designer 534, KPI or chart builder 536, access server 538, etc. The customer may access the data via a portal 540.

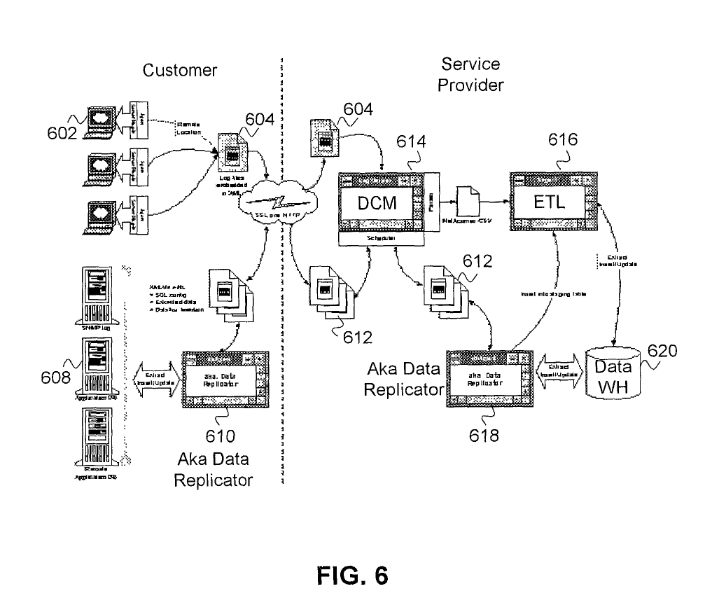

FIG. 6 is a schematic diagram depicting application service provider and customer architecture 600 in accordance with an embodiment of the present invention. One or more user computers 602 may be located at a remote location. The customer can obtain information associated with the user computer 602 depending on the where the user computer 602 visits on the customer web site. A web log 604 is generated from this information associated with the user computer 602 in the current embodiment. The web log 604 is provided to the service provider via a network 606. The web log 604 information (i.e. data) may be stored in customer servers 608. 606. The customer servers 608 may provide web log 604 information to the service provider, as well as departmental data associated with the customer itself. The information from the customer servers 608 is sent to the data replicator 610. The data replicator 610 may send and receive data, as well as store data in the servers 608 or extract data from the servers 608. The data 612 from the data replicator 610 and the customer servers 608 is delivered to the service provider via the network 606 in the present embodiment. The web log 604 data and the data 612 from the customer servers 608 is delivered to the data collection manager 614 (DCM) at the service provider side. The data collection manager 614 may then deliver data to the ETL processor 616 or the data replicator 618 on the service provider side. The ETL processor 616 may cleanse and integrate the data received. Cleansing data may include obtaining accurate information about the user by determining a correct IP address or domain and ascertaining accurate information associated therewith. The data replicator 618 on the service provider side may deliver the data to the data warehouse 620. The data replicator 618 on the service provider side may also deliver the data to the ETL processor 616. The ETL processor 616 delivers the data to the data warehouse 620 in the current embodiment.

The data in the data warehouse 620 may be extracted and updated and sent back to the ETL processor 616. Furthermore, the data from the data warehouse 620 may be extracted by the data replicator 618 on the service provider side and eventually sent back to the customer servers 608 on the customer side. The customer may access cleansed and integrated data by accessing the data warehouse 620 or by accessing its own servers, the customer servers 608, where cleansed and integrated information is stored. Accordingly, the information stored in the data warehouse 620 and the customer servers 608 may be updated by the respective data replicators 618, 610, in order to allow the customer to access current information.

The data collection manager 614 (DCM) can process web server log files (i.e. web log data). In addition, it may be a data transport manager for rich sets of data such as log data, relational data, SNMP, XML, etc. The DCM 614 may process diverse website environments, from low traffic single server environment to high traffic, global web farm consisting of multiple servers dispersed geographically. It may provide support for major web server platforms, such as Apache, Microsoft IIS, Netscape Enterprise, etc., as well as support for major server operating systems, such as Solaris, Linux, Windows NT/2000, etc. The DCM 614 may support data sources in addition to web server logs. For example, it may support external data sources such as existing applications, XML, SNMP, flat files, etc. It may read from a data source and also write back to a data source. The DCM 614 may also provide for a secure transfer of data. For example, it may provide support for HTTPS to provide a secure method of transferring sensitive data from remote sites. The DCM 614 may also schedule the creation and transfer of web log files and the processing thereof. This may give the customer near real time access to data.

The ETL processor 616 can convert web log data into a standard format. In addition, it can calculate sessions as well as a session page hit order. The ETL process 616 can covert an IP address into a URL or company name. Furthermore, the ETL processor may be responsible for integrating the disparate data, such as the URL, company name, firmagraphic data, demographic data, company industry code, company revenue, etc.

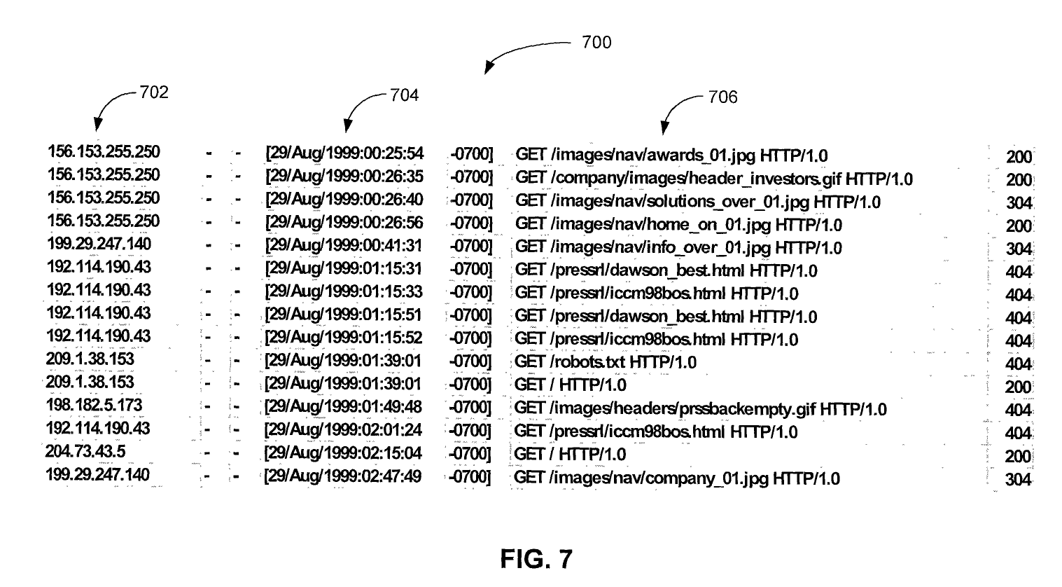

FIG. 7 is a schematic diagram depicting a typical web log 700 in accordance with an embodiment of the present invention. The first column includes IP addresses 702. The next column includes a date and time stamp 704 and the last column includes page hits 706.

A web log may include information about a user, such as the information in the columns in FIG. 7. Essentially, this information may be the result of tracking where a user went on a web site and what the user did on that website. Multiple web logs may exist from different servers. The servers may be local or remote. In addition, web servers may have options to enable the collection of additional data in the log, such as cookies and referrer pages.

A cookie is a collection of information, usually including a unique identifier and the current data and time, which is stored on the local computer of a person visiting a specific web site. The cookie is then captured in the web log whenever the web server services a request from the visitor. Cookies are used chiefly by Web sites to identify users who have previously registered or visited their site. Since the Web is sessionless, a cookie allows web sites to relate clicks to correct machine and user. This is critical for sites conducting electronic transactions because it allows shoppers to checkout with multiple items in the shopping cart. In addition, this information allows webmasters to perform some analysis on the web site from an operational perspective. Most e-commerce sites use cookies to track customer activity. For example, if a user has ever abandoned a shopping cart at a web site and returned to the site at a later data to find the shopping cart in tact (i.e. the shopping cart still includes the information previously entered by the user), a cookie was served and the web site leveraged the cookie information to associate the computer of the user with the items in the shopping cart.

Referrer pages may be important when measuring sites that are driving traffic to a customer web site. For example, a customer may want to rank the search engines that are driving visitors to the customer web site. Furthermore, partners of a customer may have agreed to some co-marketing opportunities so that the customer may want to measure the effectiveness of the co-marketing campaigns using information associated with referrer pages.

Information associated with page hits may include an operation, a page, and a protocol. The operation, page, and protocol may indicate where the user has visited and what the user did on the web page visited.

An IP address of a user is a unique identifier of the machine that is visiting the web site. Users may be load balanced across multiple machines in a single session and the web log may then register multiple IP addresses for the pages served in the session.

Web logs can be converted into a standard format. The data collection manager 614 (DCM) may process remote web logs with those collected from local servers and convert them into a common (i.e. standard) format. Although web logs may include the information displayed in FIG. 7, this information may vary among web logs in format. In addition other types of information may be included in web logs. For example, a web log from a European country may have a different format for the date and time stamp. As another example, a web log may include the URL of the user rather than the IP address.

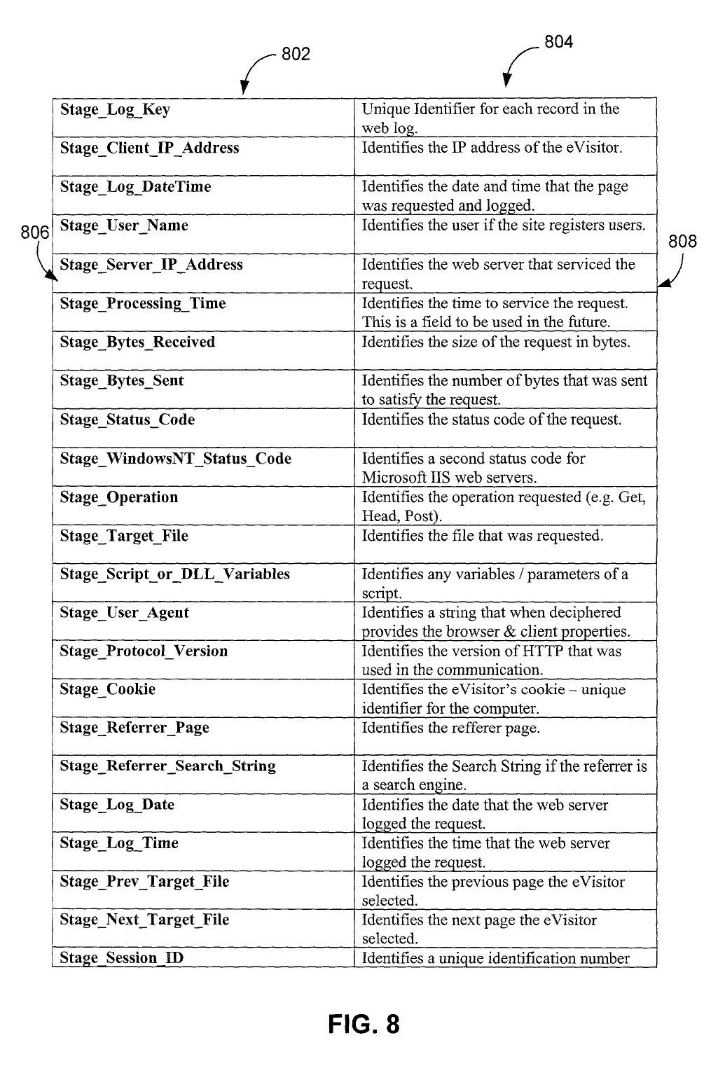

FIG. 8 is a schematic diagram depicting a standardized format 800 in accordance with an embodiment of the present invention. Each stage code in the left column 802 indicates an item from the web log that is identified in the right column 804. For example, Stage_Server_IP_Address 806 identifies the web server that serviced the request 808 of the user. The identifiers may use algorithms where calculations are desired or required.

For example, a session calculation may use an algorithm depending on the availability of cookie information. A first algorithm, for instance, may use cookie information when it is available, as well as date and time, to create a unique session ID. The algorithm may sort the data in order of cookie, data, and time. Each record may look at the previous record and if the cookie is the same and the time is within x minutes of the previous hit then the session id may be the same and the session hit order may be incremented by one. The variable x can be configurable with a default of twenty minutes. If the cookie changes or the time is greater than x minutes, then a new session id can be created.

A second algorithm, for example, may be used when cookies are not available. This algorithm can use an IP address, data, time, and user agent to create a session ID. This algorithm may be an estimated measurement of the session and may not exact because of load balancing that changes a user's IP address in the middle of a session and multiple users may be coming from the same IP address. This algorithm can sort the data in order of IP address, user agent, date, and time. Each record can look at the previous record and if the IP address and user agent is the same and the time is within x minutes of the previous hit, then the session id may be the same and the hit order may be incremented by one. The variable x can be configurable with a default of twenty minutes. If the IP address or user agent changes or the time is greater than x minutes, a new session id can be created.

Once the data is in a standard log format, the process of integrating and cleansing disparate data may be repeated for each customer. Converting the data into a standard log format may allow this process to be standardized across all customers. Furthermore, the data conversion may allow this process to be performed more efficiently.

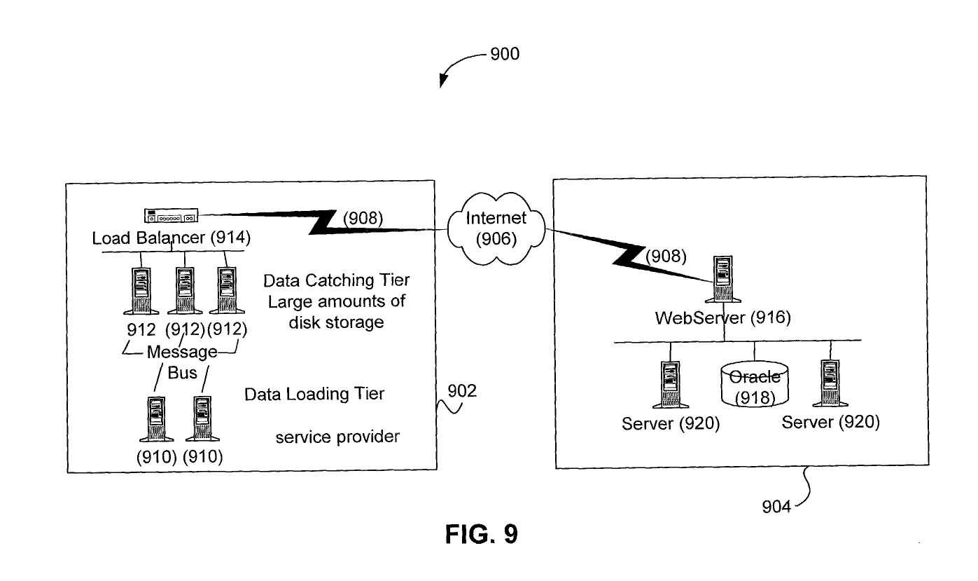

FIG. 9 is a schematic diagram depicting a hardware implementation of a data replicator 900 in accordance with an embodiment of the present invention. A service provider site 902 and customer site 904 share information via a network 906, such as the Internet. Data may be transported over HTTP 908, for example, or HTTPS. The service provider site 902 may include servers acting as data loading tiers 910. Data catching tiers 912 may extract data from the data loading tiers 910 and store the data. The data catching tiers 912 deliver data to a load balancer 914 for transport to the customer site 904 via the network 906 in the current embodiment. Data is delivered to a web server 916 at the customer site 904. The data may be stored in a database 918, such as an ORACLE (TM) database, at the customer site. The data may also be stored on servers 920 at the customer site 904. Alternatively, the customer site 904 may access the data at the customer site 902 through its web server 916.

The data replicator may extract data such as web log data from the customer site 904. In addition, the data replicator may extract other types of data, such as sales transactions and shopping cart activity. The data replicator may extract data, send it across the network, and import the data into a remote system. The data replicator may also copy data from one location to another. It can synchronize two or more disconnected data stores within an enterprise or across the network, such as the Internet. The data stores may be relational databases, file systems, etc.

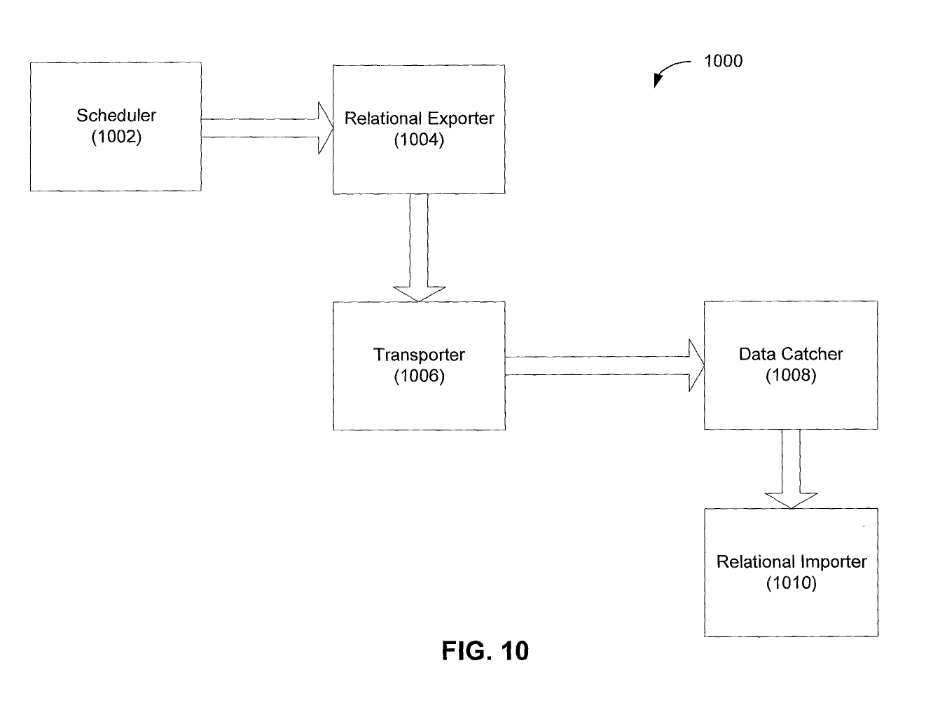

FIG. 10 is a flowchart depicting software components 1000 of a data replicator in accordance with an embodiment of the present invention. The software components 1000 of the data replicator in the present embodiment may include a scheduler 1002 or a relational exporter 1004. A transporter 1006, data catcher 1008, or a relational importer 1010 may also be software components 1000.

The scheduler 1002 may start an extraction process at intervals determined by the customer. The customer can also start the process manually. A manual task may be a scheduled task that only runs once. The relational exporter 1004 components may be responsible for the extraction process. The extraction process may run periodically and the customer may be in control of the interval. The extraction process can wake up, gather changes made to the database, package the changes, and send them to a server.

The transporter 1006 component may initiate the transport process. The transport may be via http, for example. In order to support high-bandwidth network services, such as Internet services, HTTP headers may not be used to transmit data or metadata. The data replicator agents may “push” data to the service provider at specified intervals. Data may be encoded as XML, for example. Data may also be encrypted.

The data catcher 1008 component may initiate a data catching process. Receiving files may be separate from processing the files. Thus, the data catcher 1008 component may be a dumb file catcher that makes sure file names are unique. Alternatively, the data catcher 1008 component may be logic that executes when new files are available (the “importer”). The catcher may notify another component when a new file has arrived. This notification may start an import process.

The relational importer 1010 component may perform the import process. The relational importer 1010 may receive a file and import the data into a table. The file may also be stored in a special directory.

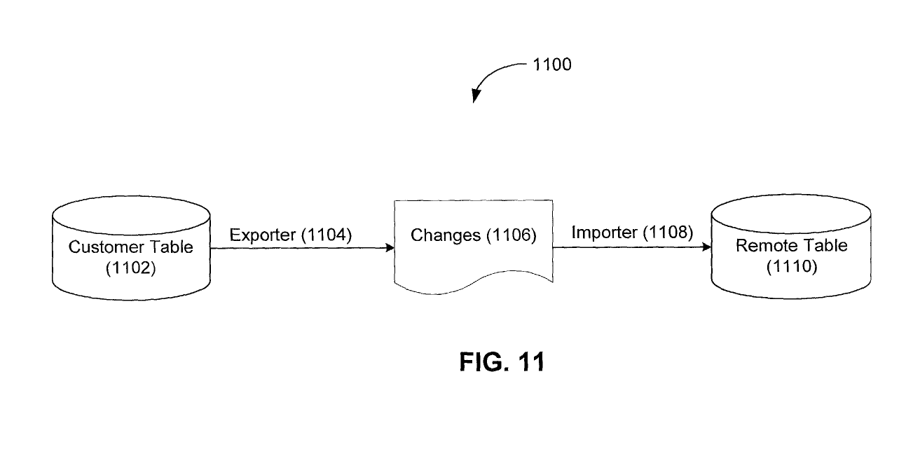

FIG. 11 is a schematic diagram depicting an import and export process 1100 of a data replicator in accordance with an embodiment of the present invention. A customer table 1102 may include departmental data associated with the customer. Data from the customer table 1102 is updated and these changes 1106 (i.e. updates) are gathered by the export process 1104. The changes 1106 are then applied to a remote table 1110 via an import process 1108.

Relational data can be handled differently depending on the nature of the data. For example, where data is new, there may be no need to keep track of updates. On the other hand, other data may need to be updated. In the latter example, consider a table including sales representatives. Sales representatives territories, for instance, may change constantly. In addition, new sales representatives may be added to the system. Sales representatives that leave the customer's company, for example, may need to be removed from the database. Accordingly, updateable data may be handled by replicating the table.

For example, two identical copies of the table may exist. One copy may reside at the customer site, while the other copy may reside at the service provider site. Changes that are made to the copy at the customer side may be gathered by an export process 1104 and applied to the remote table 1110 via an import process 1108. The data replicator may then transmit changes made to a local table to a remote table. Changes may include updates, deletes, inserts, etc.

The extraction and import processes may communicate via metadata. Metadata can tell the extractor what to extract and tell the importer how to process fragments that describe the changes.

In addition to the above mentioned examples, various other modifications and alterations of the structure may be made without departing from the invention. Accordingly, the above disclosure is not to be considered as limiting and the appended claims are to be interpreted as encompassing the entire spirit and scope of the invention.

### INDUSTRIAL APPLICABILITY

A great need exists in the industry for the integration of data for providing departmental analysis to a customer. This is especially true for customers that provide online information or services. The present invention provides for the integration of disparate data, which achieves the desired goals.

For the above, and other, reasons, it is expected that the data integration method of the present invention will have widespread applicability. Therefore, it is expected that the commercial utility of the present invention will be extensive and long lasting.

What is claimed is:

1. A method for providing analytical information to a customer comprising the steps of:
(a) receiving departmental data from a customer;
(b) receiving a first set of data associated with a user from the customer;
(c) accessing a second set of data associated with the user;
(d) integrating the data;
(e) storing the integrated data in a warehouse; and
(f) providing analytical information to the customer based on the integrated data in the warehouse.

2. The method as recited in claim 1, wherein the second set of data associated with the user is accessed from at least one of a third party database and a server associated with a service provider.

3. The method as recited in claim 1, wherein the departmental data from the customer includes at least one of: customer relationship management, marketing, operations, sales force, and transactions.

4. The method as recited in claim 1, wherein the first set of data associated with the user includes web log data.

5. The method as recited in claim 4, wherein the web log data is converted into a standard format.

6. The method as recited in claim 4, wherein the web log data is collected from at least one of a local server and a remote server.

7. The method as recited in claim 1, wherein the analytical information may be provided to the customer via at least one of a portal, spatial mapping, a query, and a handheld device.

8. The method as recited in claim 1, further comprising allowing the customer to access the warehouse to perform at least one of extraction of data and insertion of new data.

9. The method as recited in claim 1, wherein the second set of data associated with the user includes at least one of firmagraphic data, demographic data, industry code, and revenue.

10. A computer program embodied on a computer readable medium for providing analytical information to a customer comprising the steps of:
(a) a code segment that receives departmental data from a customer;
(b) a code segment that receives a first set of data associated with a user from the customer;
(c) a code segment that accesses a second set of data associated with the user;
(d) a code segment that integrates the data;
(e) a code segment that stores the integrated data in a warehouse; and
(f) a code segment that provides analytical information to the customer based on the integrated data in the warehouse.

11. The computer program as recited in claim 10, wherein the second set of data associated with the user is accessed from at least one of a third party database and a server associated with a service provider.

12. The computer program as recited in claim 10, wherein the departmental data from the customer includes at least one of: customer relationship management, marketing, operations, sales force, and transactions.

13. The computer program as recited in claim 10, wherein the first set of data associated with the user includes web log data.

14. The computer program as recited in claim 13, wherein the web log data is converted into a standard format.

15. The computer program as recited in claim 13, wherein the web log data is collected from at least one of a local server and a remote server.

16. The computer program as recited in claim 10, wherein the analytical information may be provided to the customer via at least one of a portal, spatial mapping, a query, and a handheld device.

17. The computer program as recited in claim 10, further comprising allowing the customer to access the warehouse to perform at least one of extraction of data and insertion of new data.

18. The computer program as recited in claim 10, wherein the second set of data associated with the user includes at least one of firmagraphic data, demographic data, industry code, and revenue.

19. A system for providing analytical information to a customer comprising the steps of:
(a) logic that receives departmental data from a customer;
(b) logic that receives a first set of data associated with a user from the customer;
(c) logic that accesses a second set of data associated with the user;
(d) logic that integrates the data;
(e) logic that stores the integrated data in a warehouse; and
(f) logic that provides analytical information to the customer based on the integrated data in the warehouse.

20. The system as recited in claim 19, wherein the second set of data associated with the user is accessed from at least one of a third party database and a server associated with a service provider.
